(19) United States
(12) Patent Application Publication
(10) Pub. No.: US 2012/0325607 A1
(43) Pub. Date: Dec. 27, 2012

(54) TRANSPORT DEVICE HAVING A CONVERTIBLE WORK SURFACE

(75) Inventors: Rustin Webster, Birmingham, AL (US); Mark D. Roberts, Huntsville, AL (US)

(73) Assignee: Intuitive Research and Technology, Huntsville, AL (US)

(21) Appl. No.: 13/529,426

(22) Filed: Jun. 21, 2012

Related U.S. Application Data
(60) Provisional application No. 61/499,471, filed on Jun. 21, 2011.

(51) Int. Cl. A45C 13/00; B62B 1/12

(52) U.S. Cl. 190/115; 280/30

(57) ABSTRACT

A transport device comprises a luggage for carrying a load that is movable over a support surface on one or more wheels. A handle assembly is coupled to the luggage having an extendible handle for handling the load. A foldable support assembly has a work surface that is pivotable between a closed position when the foldable support assembly is folded and an open position when the foldable assembly is unfolded. The luggage has a side that forms housing about the handle assembly for enclosing the foldable support assembly when the foldable support assembly is folded such that the work surface becomes an outer surface of the luggage in its closed position thereby concealing the handle assembly and the foldable support assembly from view.

### CROSS REFERENCE TO RELATED APPLICATIONS

This application is a nonprovisional of U.S. Provisional Patent Application No. 61/499,471 filed on Jun. 21, 2011.

### FIELD OF THE INVENTION

The present invention relates generally to a luggage having a convertible surface. More particularly, the present invention relates to a luggage having a foldable support assembly configured to convert an outer surface of a luggage into an adjustable height work surface that can be used as a work table, game table, leg rest, chair, shelf, or another purpose.

### BACKGROUND OF THE INVENTION

Airports typically do not provide adequate work surfaces in terminal seating areas, which limits a traveler's comfort level especially when using electronics (e.g., laptops, handheld portable game systems and music players, etc.) and/or non-electronic forms of entertainment (e.g., playing cards, books, magazines, board games, etc.).

Several ideas have been conceived in attempts to address this need for a work surface in terminal waiting areas. Deborah Barton received a United States patent (U.S. Pat. No. 5,529,322) on Jun. 25, 1996 for a combination transport device and portable work surface. Barton's prior art wheeled transport device is depicted in FIGS. 1A-1C. Referring to FIG. 1A a walking person 100a is shown pulling a luggage cart 102 having an extensible handle assembly 104 and wheels 106, where the extensible handle assembly 102 comprises a telescopic pole arrangement. The same luggage cart 102 is shown in FIG. 1B being used to transport luggage 108 and in FIG. 1C the luggage cart 102 is shown having been reconfigured such that the handle assembly has been lowered, the wheels are no longer mobile, and it provides a work surface 110 supported by the extensible handle assembly 104. Specifically, a seated person 100b is shown working on a computer 112 placed upon the surface 110, where the luggage 108 is not used with the luggage cart 102 to provide the surface 110.

FIGS. 2A-2B depict a prior art portable workspace for laptop computers described in U.S. patent application 20050099102, filed Aug. 26, 2004 by Arthur Villarreal. Referring to FIG. 2A, portable workspace 200 comprises a main compartment 202 on wheels 106 having front doors 204, a drawer 206, two hinged surfaces 110a 110b that can be folded up to provide a horizontal work surfaces, and a hinged top portion 208 that can be opened to provide a third horizontal work surface 110c. Although the portable workspace 200 was not intended for luggage, it does provide various compartments for contents that could be used for clothing, shoes, and the like as would typically be included in a luggage. The horizontal work surfaces under this arrangement is supported by the compartment into which they are integrated.

FIGS. 3A-3E depict a prior art luggage 302 with an extensible handle assembly 104 supported by parallel handle rods that are housed on the back of the luggage. This luggage is described in U.S. Pat. No. 6,471,019, issued Oct. 29, 2002 to Jacqueline N. Miller with a deployable and retractable tray table assembly having a work surface 110 that is mounted on the back of the luggage 108. Referring to FIGS. 3A-3E, the tray table (or work surface) 110 is stowed within and completely contained by a compartment 304 when not deployed. By unzipping the compartment 304, which is a protruded extension on the back of the luggage and not a part of the housing within which the extendible handle rods 104 are positioned, and sliding the tray table and extension member upwardly, the tray table can be extended upwardly and pivoted to a support position. In the support position, the tray table 110 can rest upon the top of the luggage 108 and the extension member can be locked in place so that it cannot slide downward. The compartment 304 can be closed up around the extension member when the tray table is deployed. One of the drawbacks of this arrangement is that the mounting assembly protrudes from the back of the luggage extending the total width of the luggage.

FIGS. 4A-4C depict a prior art portable work surface assembly 400 for attaching to extensible handle assemblies 104 of luggage 302 or luggage carts 102 as described in U.S. Pat. No. 6,105,508, issued Aug. 22, 2000 to Jon B. Ryburg. Referring to FIG. 4A-4C, luggage 302 comprises an extensible handle assembly 104, wheels 106, and luggage 108. Portable work surface assembly 400 is supported by the handle support members 402 of the extensible handle assembly 104 of the luggage 302. The handle support members 402 telescopically extend out of or retract into handle rods 404. The portable work surface assembly 400 comprises a work surface 110, an extensible leg assembly 408, and frictional engagement means (e.g., clamps) 406 for attaching to handle support members 402 that have been extend out of handle rods 404. As such, the portable work surface assembly is entirely external to the luggage 302. One of the drawbacks of this arrangement is that most of the support for the work surface is placed on the extendible handle assembly 104, which may be flimsy.

FIGS. 5A-5C depict a prior art luggage 302 with a extensible handle assembly 104 including an foldable supportive wheel structure 502 which is incorporated within the extensible handle assembly 104. Referring to FIGS. 5A-5C, the foldable supportive wheel structure 502 provides additional wheels 106 to the luggage 302 comprises foldable rods 504 that are attached to the handle support members 402 of the extensible handle assembly 104 using pins 506. The two rods have slits on their inside surfaces allowing the pins 506 to slide up and down the slits as the handle rods are extended from or retracted into the rods. When the handle rods 402 are extended outside the luggage 302 the foldable rods 504 of the foldable supportive wheel structure can be folded such that the additional wheels 106 can be used to provide additional support to the luggage 302. As such, the foldable supportive wheeled structure is attached to the handle rods 402 of the luggage 302 and is extracted from inside the luggage 302 to provide an extra set of wheels outside the luggage 302.

Generally, there remains a need for an improved luggage that provides a stable work surface within the confines of the luggage housing.

### SUMMARY OF THE INVENTION

Briefly, according to one aspect of the invention, a transport device comprises a luggage for carrying a load that is movable over a support surface on one or more wheels. A handle assembly is coupled to the luggage having an extendible handle for handling the load. A foldable support assembly has a work surface that is pivotable between a closed position when the foldable support assembly is folded and an open position when the foldable assembly is unfolded. The luggage has a side that forms a housing about the handle assembly for enclosing the foldable support assembly when the foldable support assembly is folded such that the work surface becomes an outer surface of the luggage in its closed position thereby concealing the handle assembly and the foldable support assembly from view.

According to more detailed features of the invention, the foldable support assembly and handle assembly are pivoted to each other via one or more pins that link one or more pivot points on the foldable support assembly to one or more handle assembly support points that support the handle assembly on a support section of the luggage.

According to still detailed features of the invention, the foldable support assembly further comprises an extended support assembly attached to the work surface for supporting the work surface on the support surface.

Briefly, according to another aspect of the invention, a transport device comprises a support section positioned towards the bottom of the transport device for carrying a load over a support surface on one or more wheels. A handle assembly coupled to the support section has a lower part positioned towards the bottom of the transport device and a higher part positioned towards the top of the transport device. The higher part of the handle assembly is terminated by a handle for the transport device and the lower part of the handle assembly comprises one or more handle assembly support points for supporting the handle assembly above the support section. A foldable support assembly coupled to the support section has a higher part with one or more work surface support points for pivotably coupling a work surface that is pivotable between a closed position when the foldable support assembly is folded and an open position when the foldable assembly is unfolded. The lower part of the foldable support assembly comprises one or more pivot points for pivotably supporting the foldable support assembly above the support section.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIGS. 1A-1C depict a prior art combination transport device and portable work surface;

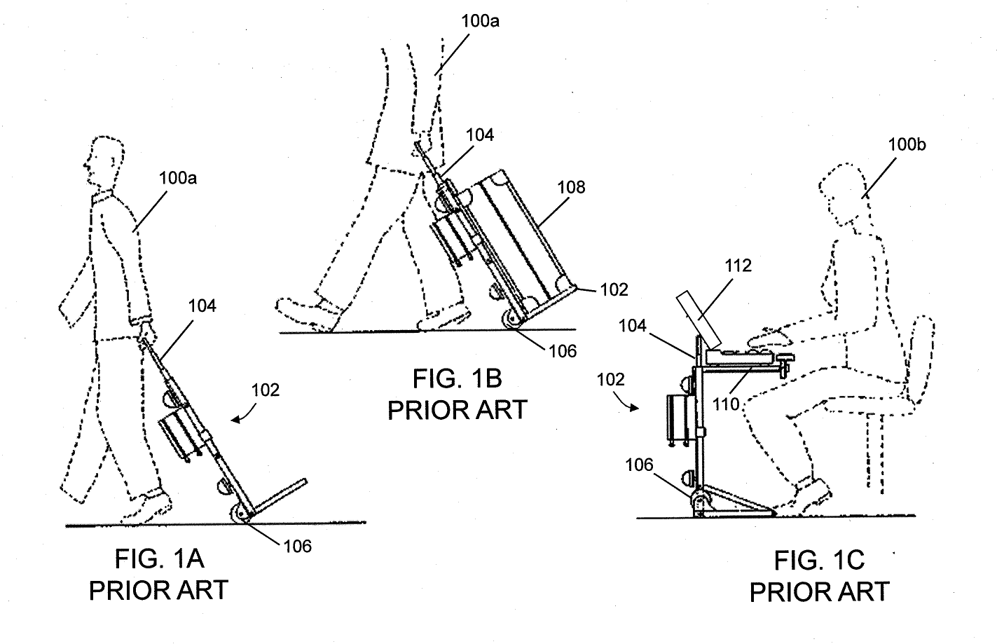

FIGS. 2A and 2B depict a prior art portable workspace for laptop computers;

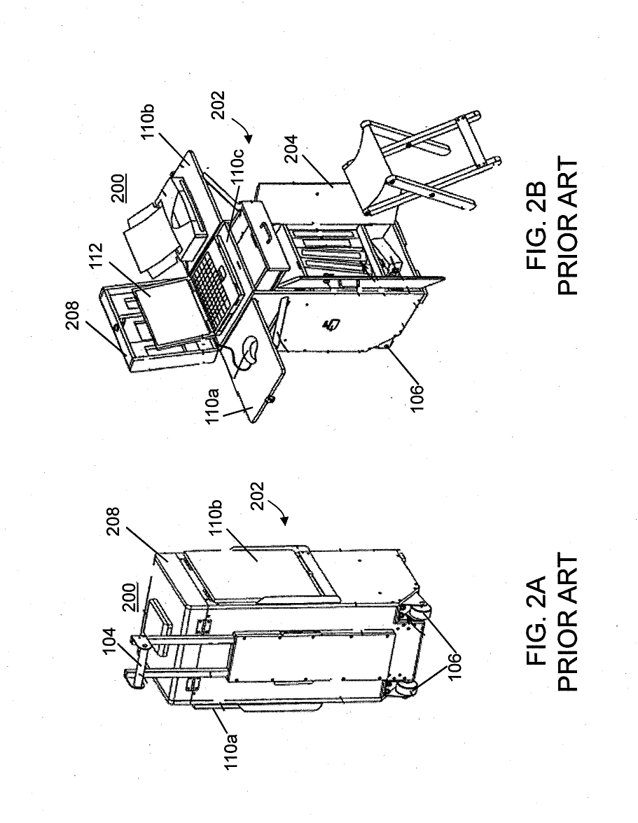

FIGS. 3A-3E depict a prior art luggage having a deployable and retractable tray table assembly mounted to the back of the luggage;

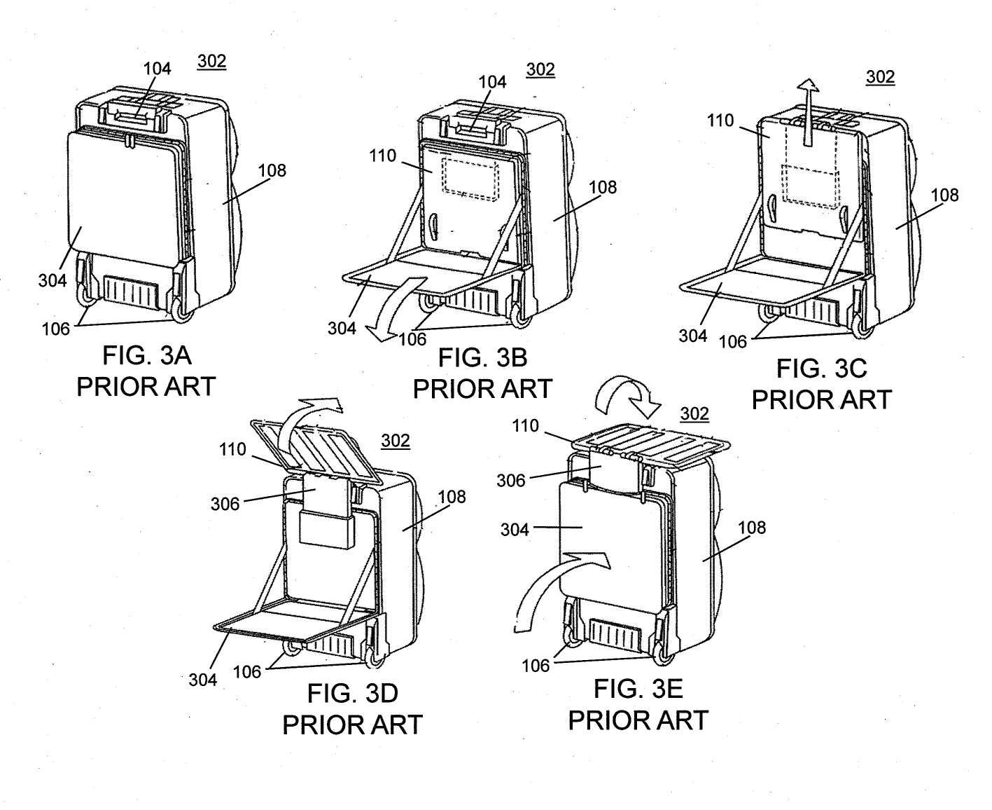

FIGS. 4A-4C depict a prior art portable work surface assembly for attaching to extensible handle assemblies of luggage or luggage carts;

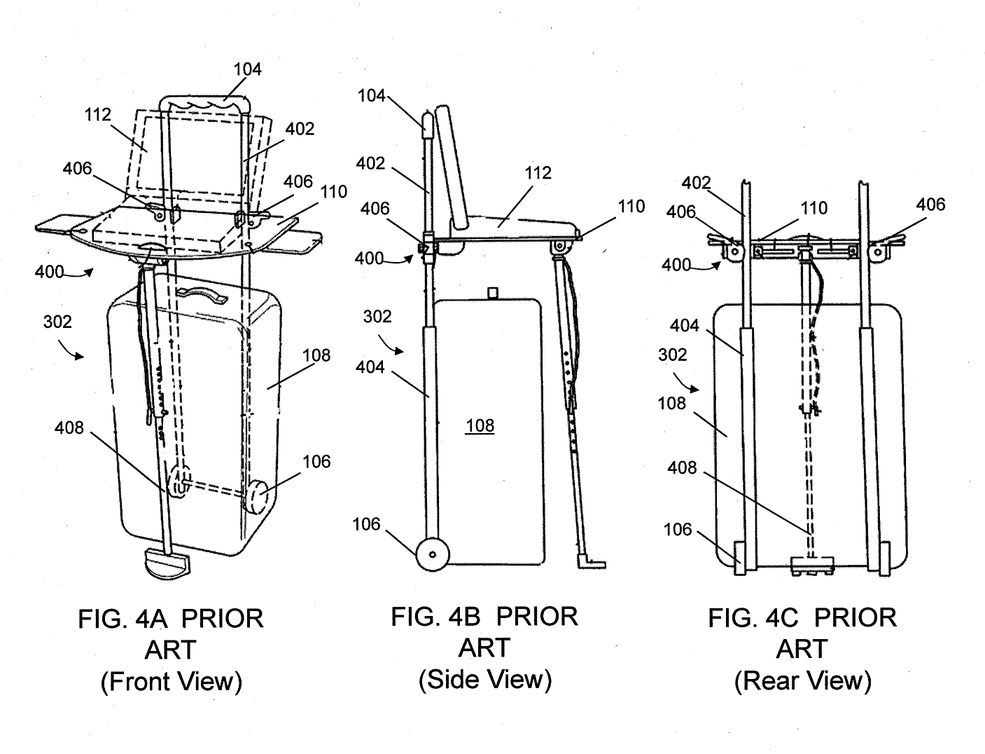

FIGS. 5A-5C depict a prior art luggage with an extensible handle assembly including an foldable supportive wheel structure which is incorporated within the extensible handle assembly;

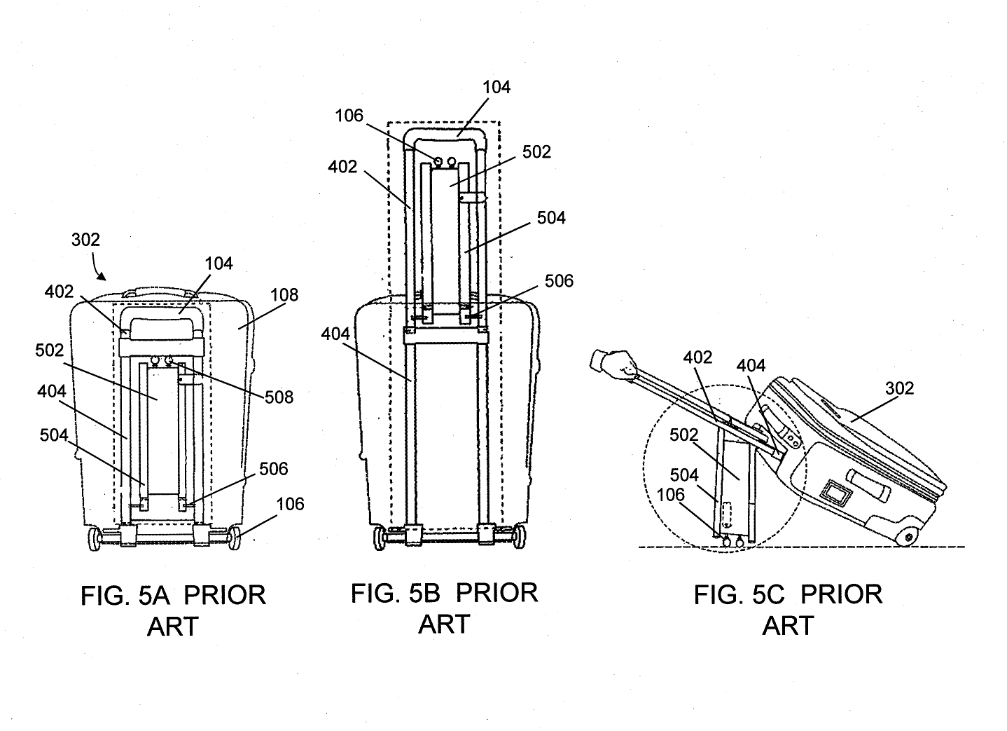

FIG. 6A depicts an exemplary luggage according that incorporates one embodiment of the present invention;

FIGS. 6B-6D depict an exemplary foldable support assembly in accordance with one embodiment of the invention that is integrated with the exemplary luggage of FIG. 6A;

FIG. 7A depicts a rear view of one embodiment of the invention;

FIG. 7B depicts the rear view of the embodiment of the invention of FIG. 7A;

FIGS. 8A-8E depict oblique projections of a foldable support assembly in accordance with another embodiment of the invention;

FIGS. 9A and 9B depict front and back views of the embodiment of the invention of

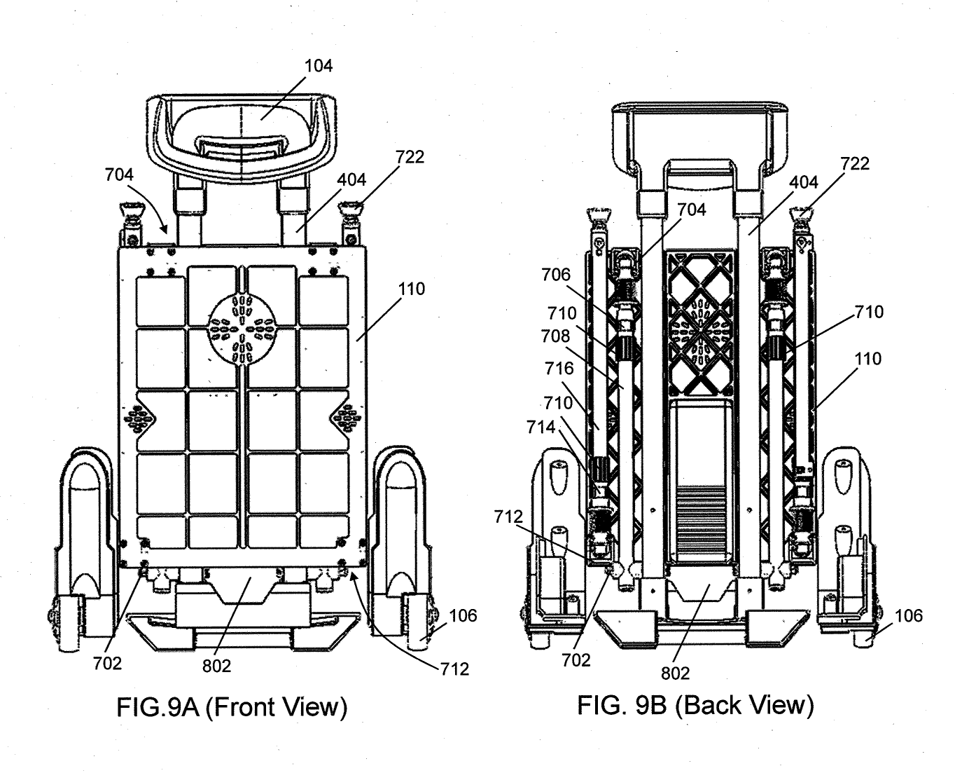

FIGS. 8A-8E; and

FIG. 10 depicts another exemplary embodiment of the invention where a covering is provided over the surface when in its closed positions.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art. Like numbers refer to like elements throughout.

The present invention provides an improved transport device such as a luggage with a stable work surface that is self contained within the periphery of luggage housing. For example, one embodiment of the present invention provides a transport device having a foldable support assembly configured to convert an outer surface (e.g., back surface) of a luggage into an adjustable height work surface that can be used as a work table, game table, leg rest, chair, shelf, or another purpose. The surface converts from a closed position where it functions as an outer surface of the luggage to an open position where it functions as a work surface. In the closed position, the foldable support assembly is folded beneath the surface such that it is concealed within the luggage with no protruding portions. As the surface is converted to its open position, the foldable support assembly unfolds to provide support to the work surface in combination with the luggage. As further described below, the frame that supports the foldable support acts independent of the handle rods that are used for wheeling the luggage around, thereby substantially increasing support stability.

The transport device of the present invention has a top end and a bottom end with a support section that is positioned towards the bottom end of the transport device for carrying a load. The support section is movable over a support surface on one or more wheels. A handle assembly is coupled to the support section for handling the load. As herein used, the term “couple” includes direct or indirect mechanical attachment or physical connection of two components to each other. A direct mechanical attachment or physical connection between two components is made without connection through intervening components. An indirect mechanical attachment or physical connection between two components is made through one or more direct attachments or physical connections between one or more intervening components. The handle assembly has a corresponding lower part positioned towards the bottom of the transport device and a corresponding higher part positioned towards the top of the transport device. The higher part of the handle assembly is terminated by a handle for the transport device and the lower part of the handle assembly comprises one or more handle assembly support points for supporting the handle assembly above the support section.

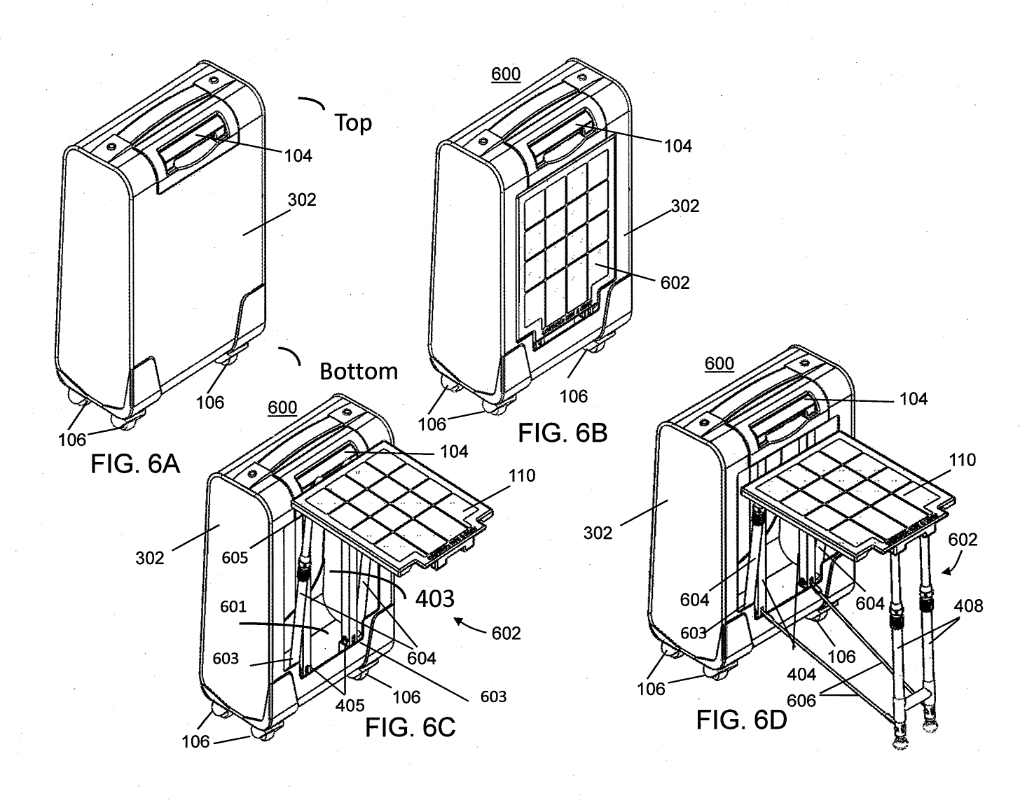

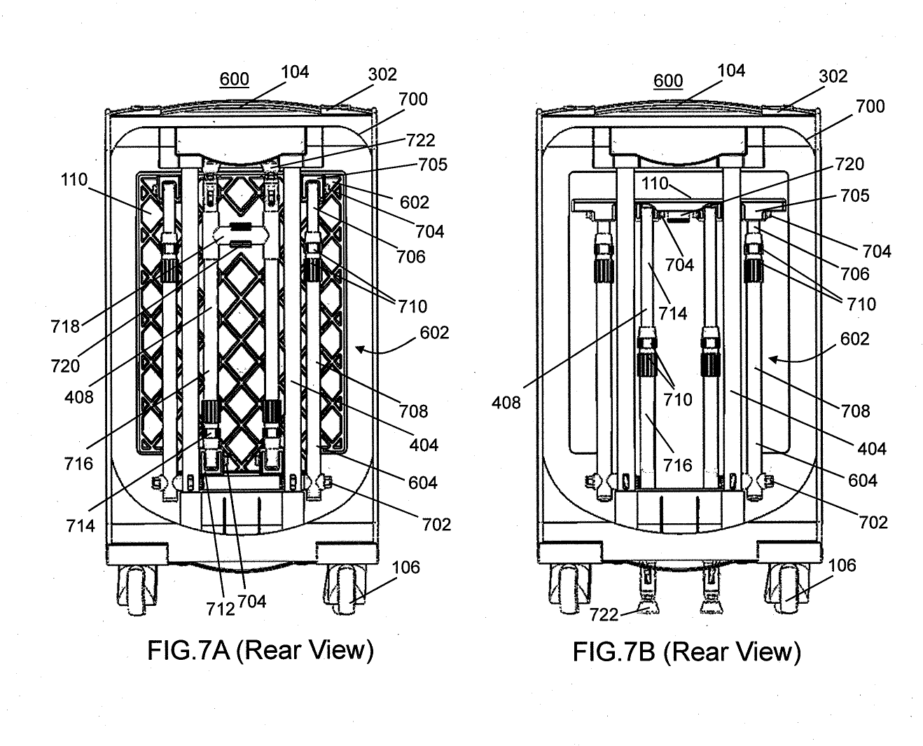

The transport device also has a foldable support assembly coupled to the support section. The foldable support assembly also has a corresponding lower part towards the bottom of the transport device and a corresponding higher part towards the top of the transport device. The higher part of the foldable support assembly comprises one or more work surface support points for pivotably attaching a work surface that is pivotable between a closed position and an open position and the lower part of the foldable support assembly comprises one or more comprising pivot points (shown with reference numeral 603 in FIG. 6C) that also provide foldable assembly support points for supporting the foldable support assembly above the support section. A pivot is coupled to the foldable support assembly at a pivot point to enable a radial movement the foldable support assembly above the support section. In one embodiment, the pivot point is on the handle assembly where the radial movement of the foldable support assembly originates at the handle assembly. Alternatively, the pivot is a point on the support section for pivotally attaching the foldable support assembly and support section to each other.

FIG. 6A depicts an exemplary transport device 600 comprises a luggage 302 towards its bottom and a handle 104, which is part of a handle assembly, for handling a load associated with the luggage 302 at its top. FIGS. 6C and 6D show a support section 601 integrated with the luggage 302 and two parallel handle rods 404 attached to the support section 601 at one or more handle assembly support points 405 at the lower parts of the handle assembly. The handle assembly, which comprises the two parallel handle rods 404 is at least partially disposed within a housing 403 formed about handle rods 404 on one side, e.g., back side, of the luggage 302 around the handle rods 404. As shown in FIGS. 6C and 6D, the two parallel handle rods 404 are attached to a support section 601 at one or more handle assembly support points 405 at the lower parts of the handle assembly. The support section 601, which supports the load, is movable over ground on one or more wheels 106. In the embodiment shown in FIGS. 6A-6D, the support section 601 is part of or otherwise integrated with the luggage 302. In another embodiment shown in FIGS. 8A-8D, the support section 601 comprises a base section 801 for carrying the load similar to a hand truck or dolly.

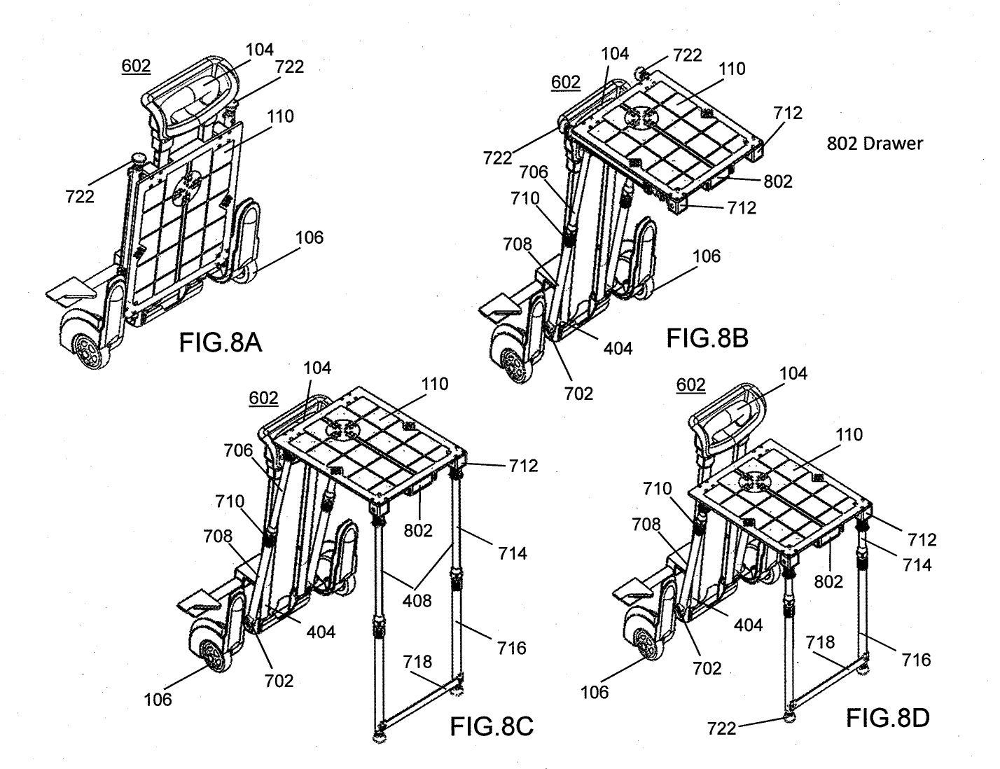

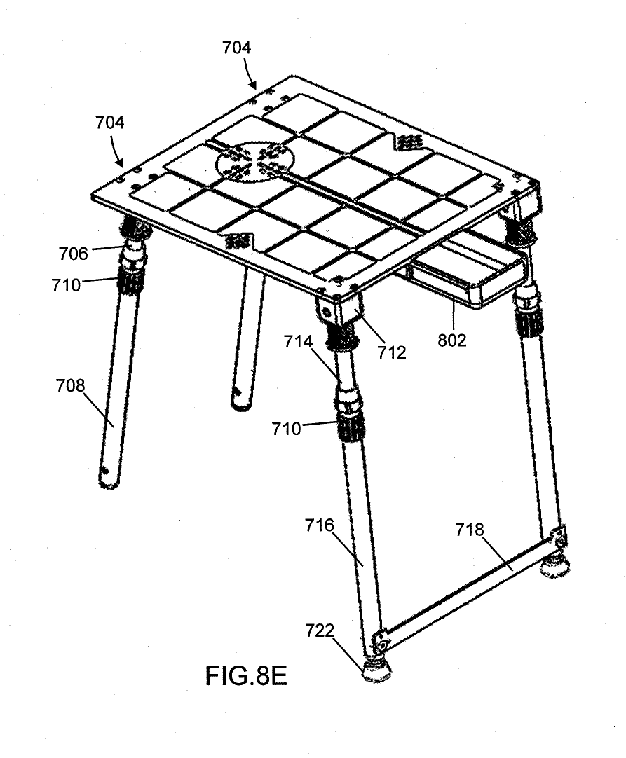

The transport device 600 also comprises a foldable support assembly 602 having a lower part closer to the bottom of the transport device and a higher part closer to the top of the transport device. The lower part of the foldable support assembly comprises one or more foldable assembly support and pivot points 603 for supporting the foldable support assembly above the support section and allowing for pivoting of the foldable support assembly 602. As shown in FIG. 6C, the one or more pivot points 603 of the foldable support assembly 602 is above the support section 601. The pivot points 603 could be either on the handle assembly, e.g., rods 404, or be supported by the support section 601. FIGS. 6B and 7A show the foldable support assembly folded and FIG. 8E shows the folded support assembly unfolded. The foldable support assembly comprises a work surface 110 and work surface support rods 604 as shown in FIGS. 6C and 6D. The work surface 110 is pivotally coupled to the work surface support rods 604 at one or more work surface support points 605 provided at the higher part of the foldable support assembly 602 closer to the top of the transport device 600. As such, the work surface 110 is pivotable to be in a closed position when the foldable support assembly 602 is folded or an open position when the foldable support assembly 602 is unfolded. In FIGS. 6B-6D, the foldable support assembly 602 is disposed within the luggage 302 of FIG. 6A such that when the foldable support assembly 602 is folded the work surface 110 forms an outer surface of the luggage 302 in its closed position as shown in FIG. 6B.

The foldable support assembly can provide further auxiliary support to the work surface 110 with extensible leg rods 408 extended to ground. The extensible leg rods 408 attach to the work surface 110 at one or more auxiliary support points 607 that are at different locations from the one or more work surface support points 605. Optional cross supports 606 can add more stable support to extensible leg rods 408 on the ground support surface.

FIG. 7A depicts rear cutout 700 of one embodiment like that of FIGS. 6B-6D, where the foldable support assembly 602, including the work surface extensible leg rods 408 is configured to reside within the housing 403 when the foldable support assembly 602 is folded to position the work surface 110 is its closed position. In this way, the foldable support assembly 602 folds up entirely into the housing 403 and the work surface 110 serves as an outer surface of the luggage 302, without any protrusion from the back of the luggage.

As shown in FIG. 7A, pivotable attachment mechanisms 702 attach the extensible surface support rods 604 to handle rods 404. In this way, the foldable support assembly and handle assembly are pivoted to each other via one or more pins that link one or more pivot points 603 of the foldable support assembly and one or more handle assembly support points 405 that support the handle assembly on the support section 601. Each extensible surface support rod 604 comprises telescopic surface support rods 706 that extend from or retract into and out of surface support rods 708. The surface support rods 708 pivot upon pivotable attachment mechanisms 702 and the surface support rods 706 pivot upon pins 704 within rear surface attachment brackets 705 when transitioning from a closed position to an open position. Twistable locking devices 710 can be twisted in a first direction to tighten and thereby lock the extensible surface support rods 604 at a desired length and can be twisted in a second direction that is opposite the first direction to loosen and thereby unlock the extensible surface support rods 604 to enable them to be telescopically extended or retracted. On the bottom of the work surface 110 there are two front surface attachment brackets 705 to which extensible leg rods 408 are pivotably attached. The extensible leg rods 408 comprise telescopic leg rods 714 that are pivotably attached to the front surface attachment brackets 712 using pins 704 and which reside within leg rods 716 enabling the extensible leg assemblies 408 to extend or retract to a desired length. Twistable locking devices 710 can be used to lock and unlock the extensible leg assemblies as previously described. An optional leg cross member 718 provides added stability between the extensible leg assemblies 408. The leg cross member 718 snaps into leg cross member clamp 720 when the surface 110 is in the closed position. At the end of each extensible leg assembly 804 is a leveling foot 722 that can be used to adjust the leveling of a respective extensible leg assembly 804.

FIG. 7B depicts rear cutout view of the foldable support assembly 602 of the invention where the work surface 110 is in the open position. This view is in fact the rear view of FIG. 7A showing the extensible leg assembly in extended position to provide support to the work surface 110 on the ground via leveling feet 722. As shown, the surface 110 has rotated substantially 90 degrees from a vertical closed position to a horizontal open position. While transitioning between the two positions the extensible surface support assemblies 604 telescopically extend and pivot forward and the extensible leg assemblies 408 unfold to provide support to the surface 110. The extensible surface support assemblies 604 and extensible leg assemblies 408 can be adjusted using the locking devices 710 to achieve a desired height for the surface 110.

Referring again to FIG. 7A, the bottom of the surface 110 is shown to have a cross-hatch “milk crate” type design, which is a well known method for adding strength without using a lot of material. One skilled in the art will recognize that many alternative approaches for the surface are possible and the surface can be made of many different materials such as molded plastic, metal, wood, or the like. The surface can be a solid material or could comprise a frame with a covering such as a fabric, leather, or other material such as those commonly used to construct luggage. A covering can also be used with a solid material instead of a frame. The surface could comprise foldable components that might be hinged together. The surface could have compartments from which additional surface components could extend. The surface could also have hooks or other attachment devices integrated into it allowing other objects to be easily attached such as a mesh storage bag that might be used to hold dirty clothes or other objects while the invention is in an open position (e.g., in a hotel room).

Although the surface (table) is shown being pivotably attached to the extensible leg assemblies 804 and to extensible leg assemblies 408 using pins 704 in front and rear surface attachment brackets, various other attachment approaches could be employed including attachment approaches that enable the surface to be detached from the extensible leg assemblies 804 and to extensible leg assemblies 408, which might be desirable for cleaning, replacement, or other reasons. For example, it may be desirable to detach the surface from the luggage for use as a lap tray, which might be useful in an airport or in a hotel room bed. Under one optional arrangement, the surface could have docking station functionality that might support a computer laptop, whereby it might be desirable to be able to detach the surface from the luggage for use on a table. A detachable surface might also have small foldable extensible legs enabling it to be configured with different heights and the configured with different surface angles.

One skilled in the art will recognize that the pivotable attachment mechanisms 702 of the invention could be designed to enable the surface support rod housings 708 to be detached from the handle rods 404 thereby enabling the foldable support assembly 602 to be removed from the luggage 302 entirely. Under such an arrangement the surface support rod housings 708 could include leveling feet 722. As such, the removed foldable surface assembly 602 might resemble a table such as depicted in FIG. 8E but with the additional leveling feet.

FIGS. 8A-8E depict oblique projections of a foldable support assembly 602 in accordance with another embodiment of the invention. A drawer 802 is shown to reside between the handle rods 404. FIG. 8A show the surface 110 in a closed position. The surface 110 is shown having been rotated upward to an open position which causes the leg support assemblies to extend and pivot forward. The leg support assemblies are then pivoted downward and extended to a desired length at which point pivotable locking devices are used to lock them at the desired length. FIGS. 8C and 8D depict two different surface heights, where one skilled in the art will recognize that the twistable locking devices 110 can be used to configure the surface 110 at a given height. FIG. 8E depicts the drawer 802 in an opened position. One skilled in the art will recognize that various other configurations are possible to integrate one or more drawers (or compartments) with a surface 110 in accordance with the invention.

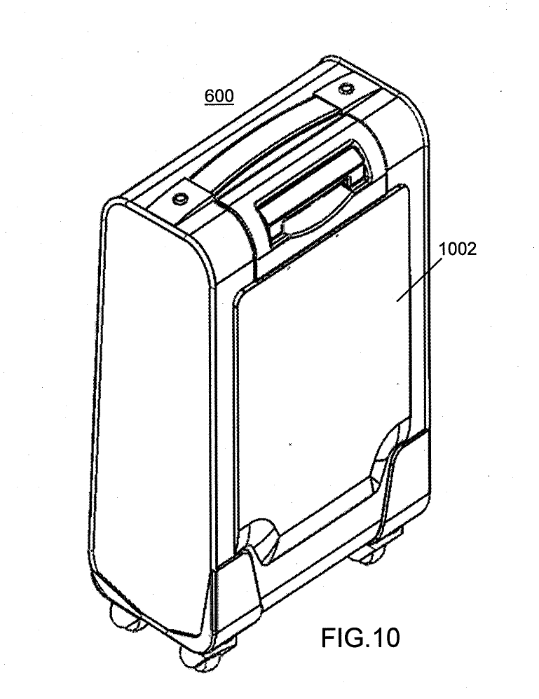

FIGS. 9A and 9B depict front and back views of the embodiment of the invention of FIGS. 8A-8E. FIG. 10 depicts another exemplary embodiment of the invention where a covering 1002 is provided over the surface 110 when in its closed position. Under one arrangement, such a covering may be attached with Velcro, snaps, using a zipper or by some other means enabling it to be folded back from the surface in order to change its position from open to closed. Under another arrangement the covering 1002 may be affixed to the surface 110 with an adhesive or some other means where by the covering is on top of the surface when it is in an open position.

Under one alternative arrangement, the convertible surface of the present invention is integrated into a wheeled backpack such as a student's backpack or a soldier's backpack, where the backpack has an extensible handle assembly and wheels.

As previously described, the surface 110 of the invention could include docking station functionality for use with a computer but could generally be configured for all sorts of purposes. For example, a surface 110 used in a wheeled backpack could have a stereo speaker system enabling a student to plug in an electronics device and hear music. Moreover, the surface could actually perform the same functionality as various electronics devices such as a computer, DVD player, audio player, and the like and could include a LCD display, keyboard, integrated pointing devices, memory, power supply, battery storage, and the like. The surface could have various compartments containing various types of supplies, for example medical supplies, school supplies, or the like making the luggage (or backpack) specially designed to meet specific needs of a given application. It might also include internet network connectivity, wireless network capabilities, lighting, and the like.

Under one arrangement, the luggage (or backpack) would have power generation capability built into the wheels enabling it to generate power while being pulled across a surface whereby generated power would be stored in a battery storage device integrated into the luggage (or backpack). The battery storage device could then be useful as a backup power supply for a laptop or other electronics device.

Generally, the foldable support assembly 602 of the present invention can be designed to interface with all sorts of other objects including other foldable support assemblies 602. For example, the surface 110 could be designed to interface with padding to provide additional comfort when used as a leg rest or seating. A plurality of foldable support assemblies might be connected together using various attachment methods to provide a larger work surface such as a picnic table, camping table, or even an emergency surgical table on a battlefield.

One skilled in the art will recognize that various types of locking mechanisms could be used in accordance with the invention to prevent unauthorized opening of the foldable support assembly 602.

One skilled in the art will recognize that any one of various approaches can be employed to conceal contents within the luggage when the foldable support assembly is extended in its open position. For example, a solid liner or a flexible material might be used.

While particular embodiments of the invention have been described, it will be understood, however, that the invention is not limited thereto, since modifications may be made by those skilled in the art, particularly in light of the foregoing teachings.

1. A transport device, comprising:
a luggage for carrying a load, said luggage being movable over a support surface on one or more wheels;
a handle assembly coupled to the luggage comprising a handle for handling the load; and
a foldable support assembly comprising a work surface that is pivotable between a closed position when the foldable support assembly is folded and an open position when the foldable assembly is unfolded, said luggage having a side that forms a housing about the handle assembly for enclosing the foldable support assembly when the foldable support assembly is folded such that the work surface comprises an outer surface of said luggage in the closed position thereby concealing the handle assembly and the foldable support assembly from view.

2. The transport device of claim 1, wherein the foldable support assembly and handle assembly are pivoted to each other at the one or more pivot points.

3. The transport device of claim 2, wherein the foldable support assembly and handle assembly are pivoted to each other.

4. The transport device of claim 1, wherein the foldable support assembly further comprises an extended support assembly attached to said work surface for supporting the work surface on the support surface.

5. The transport device of claim 1, wherein the handle assembly has a corresponding lower part positioned towards the bottom of the transport device and a corresponding higher part positioned towards the top of the transport device, wherein the higher part of the handle assembly is terminated by the handle and the lower part of the handle assembly comprises one or more handle assembly support points for supporting the handle assembly above a support section of the luggage; and wherein the foldable support assembly has a corresponding lower part towards the bottom of the transport device and a corresponding higher part towards the top of the transport device, wherein the higher part of the foldable support assembly comprises one or more work surface support points for pivotably coupling the work surface and the lower part of the foldable support assembly comprises one or more pivot points for pivotably supporting the foldable support assembly above the support section.

6. The transport device of claim 5, wherein one or more pins link the one or more pivot points of the foldable support assembly to the one or more handle assembly support points.

7. A transport device, comprising:
a support section positioned towards the bottom of the transport device for carrying a load, said support section being movable over a support surface on one or more wheels;
a handle assembly coupled to the support section for handling the load, said handle assembly having a corresponding lower part positioned towards the bottom of the transport device and a corresponding higher part positioned towards the top of the transport device, wherein the higher part of the handle assembly is terminated by a handle for the transport device and the lower part of the handle assembly comprises one or more handle assembly support points for supporting the handle assembly above the support section; and
a foldable support assembly coupled to the support section having a corresponding lower part towards the bottom of the transport device and a corresponding higher part towards the top of the transport device, wherein the higher part of the foldable support assembly comprises one or more work surface support points for pivotably coupling a work surface that is pivotable between a closed position when the foldable support assembly is folded and an open position when the foldable assembly is unfolded, and wherein the lower part of the foldable support assembly comprises one or more pivot points for pivotably supporting the foldable support assembly above the support section.

8. The transport device of claim 7, further comprising a luggage integrated with the support section, said luggage having a side that forms a housing about the handle assembly for enclosing the foldable support assembly when the foldable support assembly is folded such that the work surface comprises an outer surface of said luggage in the closed position.

9. The transport device of claim 7, wherein the foldable support assembly and handle assembly are pivoted to each other at the one or more pivot points.

10. The transport device of claim 9, wherein the foldable support assembly and handle assembly are pivoted to each other via one or more pins that link the one or more pivot points with the one or more handle assembly support points.

11. The transport device of claim 7, wherein the foldable support assembly further comprises an extended support assembly attached to said work surface at one or more auxiliary support points that are different from the one or more work surface support points.

12. The transport device of claim 11, wherein the auxiliary support assembly rests on the support surface.

13. The transport device of claim 7, wherein the work surface has an adjustable height.
